(19) United States
(12) Patent Application Publication
(10) Pub. No.: US 2016/0363919 A1
(43) Pub. Date: Dec. 15, 2016

(54) CUSTOM APPLICATION ENVIRONMENT IN A PROCESS CONTROL DEVICE

(71) Applicant: Fisher Controls International LLC, Marshalltown, IA (US)

(72) Inventor: Steven C. Anderson, Marshalltown, IA (US)

(21) Appl. No.: 14/734,399

(22) Filed: Jun. 9, 2015

(51) Int. Cl. G05B 19/042

(52) U.S. Cl. CPC G05B 19/0426; G05B 2219/23406

(57) ABSTRACT

Methods and apparatus are disclosed to provide a custom application space in a device controller. Example disclosed methods involve communicatively coupling a device controller to a host. The example host provisions the device controller and an automation device within the process control system. The example disclosed methods also involve installing a process control application into an application space in firmware of the device controller. The example process control application is to be provided by the host with permission data. The example disclosed methods also involve executing the process control application in the application space. The example process control application extends functionality of the device controller. The example disclosed methods also involve moderating access by the process control application to physical resources of the device controller. The example permission data defines which of the physical resources that the process control application has access.

### FIELD OF THE DISCLOSURE

This disclosure relates generally to controlling automation devices in process control systems and, more particularly, to providing a custom application environment in a process control device.

### BACKGROUND

Process control systems, like those used in chemical, petroleum or other processes, typically include one or more system controllers communicatively coupled to at least one host or operator workstation and to one or more automation devices via analog, digital or combined analog/digital buses. The automation devices, which may be, for example, valves, valve positioners, switches and transmitters (e.g., temperature, pressure and flow rate sensors), perform functions within the process control system such as opening or closing valves and measuring process parameters. A process controller receives signals indicative of process measurements made by the automation devices and/or other information pertaining to the automation devices, uses this information to implement a control routine and then generates control signals that are sent over the buses or other communication lines to the automation devices to control the operation of the process control system.

### BRIEF DESCRIPTION OF THE DRAWINGS

FIG. 1 illustrates an example process control system.

FIG. 2 illustrates an example device controller with a custom application environment for an automation device.

FIG. 3 illustrates an implementation of the example application manager of FIG. 2.

FIG. 4 is a flow diagram representative of an example method that may be executed to implement the application manager of FIGS. 2 and 3.

FIG. 5 is a flow diagram representative of another example method that may be executed to implement the application manager of FIGS. 2 and 3.

FIG. 6 is a block diagram of an example processor system structured to execute machine readable instructions to perform the methods represented by FIG. 4 and/or 5 to implement the example application manager of FIGS. 2 and 3.

### SUMMARY

Example disclosed methods involve communicatively coupling a device controller to a host. The example host is to provision the device controller and an automation device within the process control system. The example disclosed methods also involve installing a process control application into an application space in firmware of the device controller. The example process control application is to be provided by the host with permission data. The example disclosed methods also involve executing the process control application in the application space. The example process control application extends functionality of the device controller. The example disclosed methods also involve moderating access by the process control application to physical resources of the device controller. The example permission data defines which of the physical resources that the process control application has access.

Example disclosed device controllers associated with an automation device installed in a process control system include a device controller manager to communicatively couple the device controller to a host. The example host provisions the device controller and the automation device within the process control system. The example device controllers also include an installer to install a process control application into an application space in firmware of the device controller. The example process control application is provided by the host with permission data. The example device controllers also include an application framework handler to execute the process control application in the application space, the process control application to extend functionality of the device controller, and moderate access by the process control application to physical resources of the device controller, the permission data to define rules to moderate the access by the process control application to the physical resources of the device controller.

An example article of manufacture includes instructions which, when executed, cause a device controller to communicatively couple the device controller to a host. The example host provisions the device controller and the automation device within the process control system. The example article of manufacture also includes instructions which, when executed, cause a device controller to install a process control application into an application space in firmware of the device controller. The example process control application is provided by the host with permission data. The example article of manufacture also includes instructions which, when executed, cause a device controller to execute the process control application in the application space. The example process control application extends functionality of the example device controller. The example article of manufacture also includes instructions which, when executed, cause a device controller to moderate access by the process control application to physical resources of the device controller. The example permission data defines rules to moderate the access by the example process control application to the physical resources of the example device controller

### DETAILED DESCRIPTION

The present disclosure relates generally to automation devices in process control systems and, more particularly, to methods, apparatus and articles of manufacture to provide a custom application environment in a process control device (e.g., a device controller). Process control systems include workstations and/or servers that interact with system controllers, device controllers, and/or automation devices located in the process control system. In examples disclosed herein, the device controllers execute process control applications in addition to primary process control functions executed by firmware of the device controllers. The automation devices may be, for example, valves, valve positioners, switches and transmitters, and may perform process control functions such as opening or closing valves and measuring process control parameters. In addition to managing automation devices, device controllers may generate process data (e.g., process control information) based on information received from the automation devices. The process data may include process statistics, alarms, monitoring information, process trend information, diagnostic information, automation device status information, and/or messages from the automation devices. In some examples, device controllers may be integrated into the automation device. Alternatively or additionally, in some examples, the device controllers may be wired or wirelessly connected to the automation device.

Device controllers execute firmware to, for example, communicate with a host (e.g., a workstations, a server, etc.), communicate with the automation device, and/or generate process data. Traditionally, to update the functionality of the device controller, the device controller is taken offline and its firmware is updated. Alternatively, a mirror version of the firmware is updated in the background and switched to be the active version of firmware. Additionally, to provide custom functionality, the firmware or a module of the firmware is changed and recompiled. Such approaches limit flexibility of the device controller and can require significant amounts of time and resources.

In examples disclosed herein, the firmware of the device controller includes an application space. The application space allows the functionality of a process controller to be extended and/or updated without updating the firmware and without disrupting operation of the process controller. In the examples illustrated below, process control applications may be downloaded and executed in the application space without changing the firmware or resetting the automation device. To provide security and stability, the application space is segregated from the rest of the firmware.

An application manager defines the application space by isolating a portion of memory (e.g., read only memory (ROM), random access memory (RAM), hard disk, solid state memory, etc.) in which the process control applications executing in the application space may be stored and from which the process control applications may read and/or to which the process control application may write. Additionally, the process control applications are not able to read and/or write to other areas of the memory not defined for the application space. In examples disclosed herein, the application manager moderates access to the physical resources (e.g., network communications, automation device communications, sensors, actuators, etc.) of the device controller. In some examples, the application manager moderates the process control application by controlling accessibility (e.g., read-only access, read-write access, ability to send and/or receive message to the host, etc.) to the functions of the firmware. For example, the application manager may allow the process control application to read messages and/or data sent by the automation device, but may prevent the process control application from sending messages (e.g., command signal) to the automation device. The application manager may also control frequency of access to the physical resources. For example, the application manager may limit the frequency at which the process control application can send messages to the host (e.g., to prevent accidental or malicious denial-of-service style attacks, etc.).

In examples disclosed herein, the process control application is associated with permission data. The permission data defines the access that the process control application has to the physical resources of the device controller. For example, the permission data may specify that the process control application may send messages to the host, but not to the automation device. In such an example, if a process control application includes instructions to send a message to automation device, the application manager does not provide the corresponding functionality to process control application. In some examples, a manufacturer may set (e.g., in hardware, in firmware, etc.) different permission policies for device controllers manufactured for different customers. For example, a customer may decide that process control applications executing on device controllers in a certain process control system are not to send messages to automation devices for security purposes.

The example permission data is communicated to the device controller with the process control application. In some examples, if the process control application is installed but is not associated with permission data, the application manager does not execute the process control application. In some examples, the permission data is created when the process control application is created. In such examples, when the process control application is installed via a host, a user is prompted to confirm (e.g., accept) the permission data. In some examples, the permission data is generated separately from the process control application. For example, the permission data may be generated when the application is installed on the device controller. In some such examples, the user is prompted to select permissions for the process control application when the process control application is installed.

In some examples, to prevent malicious applications from gaining access to the functionality of the process controller firmware, the permission data may be stored in a permission data repository separate from the corresponding process control application and retrieved when the corresponding process control application is installed. In some such examples, an authentication value is pre-calculated based on the process control application. For example, the process control application may be used to calculate a hash value. In such examples, when the process control application is to be installed via the host, a new authentication value is calculated based on the process control application. In such examples, the permission file is retrieved and communicated to the process controller if the newly calculated authentication value and the pre-calculated authentication value match. In such examples, a match signifies that the process control application had not been changed since the permission data was created. Alternatively or additionally, in some examples, the permission data contains a digital signature. In such examples, the host and/or device controller does not install the permission data unless digital signature is verified (e.g., via a corresponding public key).

The application manager also includes an application framework handler that provides an interface between the application space and the firmware. In some examples, the process control application may be a compiled set of instructions. In such examples, the application framework handler provides the process control application in the application space access to libraries of functions (e.g., network communication functions, automation device communication functions, etc.) that are contained within firmware. In some examples, the process control application may be a script. In such examples, the application framework interprets the script and provides access to functions that are contained within the firmware (e.g. scripting hooks). In these examples, the process control application makes a request (e.g., via a library function call, via a hook, etc.) to the application manager to access the physical resources of the process controller, and the application manager grants or denies the request based on the permission data associated with the process control application. If the application manager grants the request, the application manager allows the library function call to the firmware. For example, if the process control application requests to read the position value of a position sensor on a valve actuator, the application manager would retrieve the value (e.g., request the firmware for the value) and pass it to the process control application.

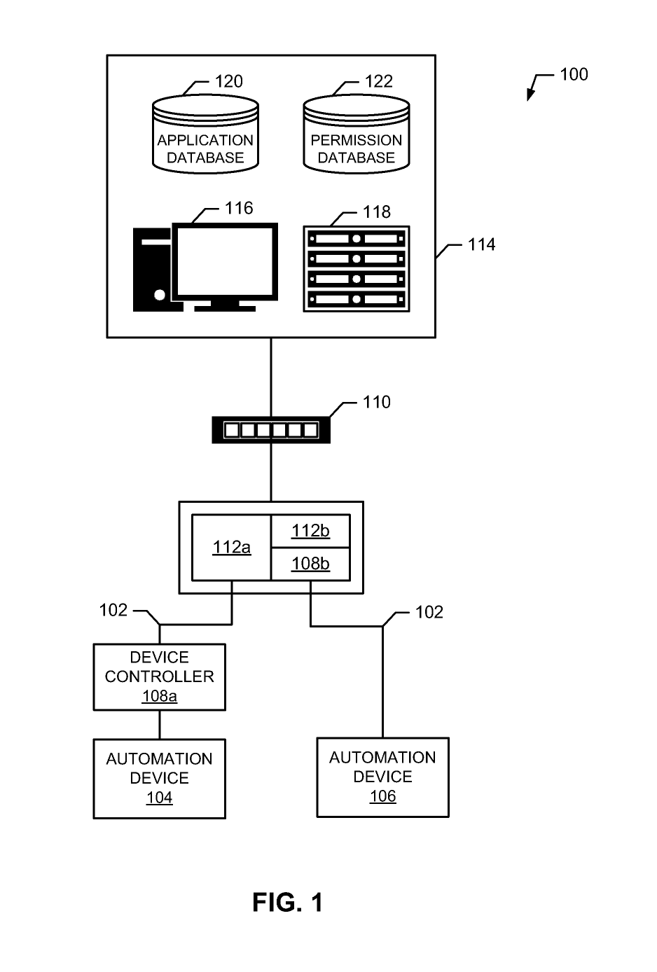

FIG. 1 illustrates an example process control system 100 usable in conjunction with the custom application environment in a device controller described herein. The example process control system 100 employs a plant process control architecture that integrates one or more smart plant capabilities including field buses 102 (such as HART® and/or FOUNDATION™ field buses), high-speed discrete busses, embedded advanced control, and advanced unit and batch management. The field busses 102 network automation devices 104, 106 and/or device controllers 108 within the process control system 100 and provide an infrastructure for a variety of applications, including device management, configuration, monitoring, and diagnostics, etc.

In the illustrated example, the process control system 100 includes the example automation devices 104, 106, the example device controllers 108a, 108b, an example system controller 110, example I/O devices 112a, 112b, and an example host 114. The example I/O devices 112a, 112b facilitate communication between the example system controller 110 and the example automation device 106 and/or the example device controller 108a. The example I/O devices 112a, 112b support a variety of modules to communicate (e.g., via digital and/or analog communication) with a variety of automation devices 106 and/or example device controllers 108a. For example, an I/O device 112b may have an analog module to interface with the automation device 106 (e.g., a three-wire temperature probe, etc.) and a digital module to interface with the device controller 108a. The example I/O devices 112a, 112b receive data from the example automation device 106 and/or the example device controller 108a and convert the data into communications capable of being processed by the example system controller 110. Additionally, the example I/O devices 112a, 112b convert data and/or communications from the example system controller 110 into a format capable of being processed by the example automation device 106 and/or the example device controller 108a. In some examples, the I/O devices 112a, 112b and the device controller(s) 108 are combined into one unit.

The example automation devices 104, 106 may, for example, include one or more instruments that control and monitor fluids (e.g., fluids, gases, semifluids, etc.) in the process control system 100. The automation devices 104, 106 may, for example, include valves, actuators, sensors, probes, proximity switches, motor starters, drives, etc. The example device controllers 108a, 108b control and/or monitor the example automation devices 104, 106. In the illustrated example, the device controller 108a, 108b reads (e.g., data from sensors, etc.) from the example automation devices 104, 106 and/or produces control signals (e.g., to control the position of a valve, to control the speed of a motor, etc.) to the example automation devices 104, 106. For example, the device controllers 108a, 108b may receive data from a position sensor and/or other sensors and may communicate control signals to control a valve and/or other devices.

The example automation device 104 is communicatively coupled to the device controller 108a. In some such examples, the device controller 108a may be integrated into the automation device 104. For example, the hardware to control an actuator on a valve may be in the same enclosure as the device controller 108a. Alternatively, the device controller 108a may be separated from the automation device 104. In some examples, the device controller 108b may be integrated with the I/O device 112b.

In the illustrated example, the device controllers 108a, 108b execute firmware to process data received from the example automation devices 104, 106 and/or the system controller 110. The example firmware may range from firmware that provides basic functionality (e.g., reporting data, control of the automation devices 104, 106, etc.) to firmware that provides advanced functionality (e.g., calculating process data, generating warning data, etc.). The firmware includes an application space in which to execute process control applications downloaded, for example, from the host 114. The process control applications extend the functionality of the firmware of the device controllers 108a, 108b by, for example, performing functions not included in the firmware. For example, the process control applications may calculate process data, control the automation devices 104, 106, generate warnings, etc. In some examples, the firmware may execute multiple process control applications in an application space and/or provide multiple application spaces. In some examples, the firmware of the device controllers 108a, 108b may have basic functionality (e.g., read/report sensor data, generate control signals, etc.), and the process control applications in the application space may be used to customize the functionality of the device controllers 108a, 108b. In such a manner, the need for firmware updates is reduced and the ability to customize functionality of the device controllers 108a, 108b is increased.

The example system controller 110 is coupled to the example host 114 via a wired or wireless network (e.g., a LAN, a WAN, the Internet, etc.). The example system controller 110 controls routines to calculate process data based on outputs from the automation devices 104, 106 and/or the device controllers 108a, 108b for process control applications including, for example, monitoring applications, alarm management applications, process trending and/or history applications, diagnostic applications, batch processing and/or campaign management applications, statistical applications, streaming video applications, advanced control applications, safety instrumented applications, event applications, etc. The system controller 110 forwards process data to the host 114 at periodic intervals and/or upon processing or generating the process data. The process data transmitted by the system controller 110 may include process control values, data values, alarm information, text, block mode element status information, diagnostic information, error messages, parameters, events, and/or device identifiers.

In the example illustrated in FIG. 1, the host 114 may include one or more workstations 116 and/or servers 118 to execute system control applications. The system control applications communicate with the example controller 110 to monitor, control, and/or diagnose the example device controllers 108a, 108b and/or the example automation devices 104, 106 in the process control system 100. For example, the process control applications may include control automation, graphical representations of the process control system 100, change management, process control editing, data collection, data analysis, etc. In some examples, the workstation 116 displays the system control applications via a user interface to render process data in a graphical format to enable a user of the workstation 116 to graphically view (via an application) the process data generated by the example device controllers 108a, 108b and/or the example automation devices 104, 106. In some examples, when the process control application executes on the server 118, an operator may establish a remote connection from a workstation (e.g., the workstation 116) to the server 118 to access to the process control application.

The example host 114 includes an example application database 120. The example application database 120 stores process control applications that may be installed in the application space of the firmware of one or more of device controllers 108a, 108b in the process control system 100. In some examples, the workstation 116 may be used to manage installation and uninstallation of the process control applications in the device controller 108a, 108b. To install a process control application, the workstation 116 sends (e.g., via block transfer) the process control application from the application database 120 to the device controller 108a, 108b via the system controller 110 and the I/O devices 112a, 112b.

In the illustrated example of FIG. 1, the example host 114 includes an example permission database 122. Permission data defines the access the process control application has to the physical resources of the device controllers 108a, 108b and/or logic conditions that regulate when the process control application is able to access with the physical resources of the device controllers 108a, 108b. For example, the permission data may specify that the process control application may send messages to the host 114, but may not send control signals to the automation devices 104, 106. As another example, the permission data may specify that the process control application may communicate with the automation device 104, 106 when a message granting such access is received from the host 114. The permission data is sent to the device controllers 108a, 108b when the process control application is sent to the device controllers 108a, 108b. In some examples, if the process control application is installed on the device controller 108a, 108b but is not associated with permission data, the firmware of the device controller 108a, 108b will not execute the process control application.

In some examples, the permission data is created when the process control application is created. In some examples, before the process control application is sent to the device controller 108a, 108b via the host 114, a user is prompted to accept the permission data. For example, the workstation 116 may display the permission data associated with the process control application and may provide a button for the user to press to indicate acceptance of the permission data. In some examples, if the user does not accept the permission data, the host 114 does not send the process control application to the device controller 108a, 108b. In some examples, the permission data is generated via the host 114 separately from the process control application. For example, a user may be prompted to select permission data when the process control application is sent to the device controller 108a, 108b. For example, the workstation 116 may display possible permissions (e.g., read from the automation device 104, 106, write to the automation device 104, 106, etc.) that can be included in the permission data and allow the user to selection which permissions to include in the permission data.

In some examples, a manufacturer of the device controller 108a, 108b includes permission data with the device controller 108a, 108b when the device controller 108a, 108b is manufactured. In some such examples, the permission data set by the manufacturer is used by the process control applications executing on the device controller 108a, 108b. For example, permission data may be included for a device controller 108a, 108b that prevents process control applications installed on the device controller 108a, 108b from reading from the corresponding automation device 104, 106 and/or writing to the corresponding automation device 104, 106. In such an example, the process control applications could not access the corresponding automation device 104 regardless of permissions set by permission data associated with a specific process control application.

In some examples, to prevent malicious process control applications from gaining access to the functionality of the firmware, when the process control application is sent to the device controller 108a, 108b, the permission data stored in the permission database 122 is sent separately. In some examples, an expected authentication value (e.g., a hash value, etc.) is pre-calculated and stored in the permission database 122. For example, after the process control application is written, a hashing function may be used on the process control application to produce the expected authentication value. In such examples, when the process control application is to be installed via the host 114, a new authentication value is calculated based on the process control application. In such examples, the permission data is retrieved and communicated to the process controller 108a, 108b if the newly calculated authentication value and the expected authentication value match. Alternatively or additionally, in some examples, the permission data stored in the permission database 122 includes a digital signature generated using a private key in accordance with a digital signature standard (DSS). In such examples, when the permission data is received from the host 114, the device controller 108a, 108b verifies the digital signature using a public key corresponding to the private key. In such examples, if the digital signature is verified, the device controller 108a, 108b installs the permission data. Otherwise, in such examples, if the digital signature is not verified, the device controller 108a, 108b discards the permission data.

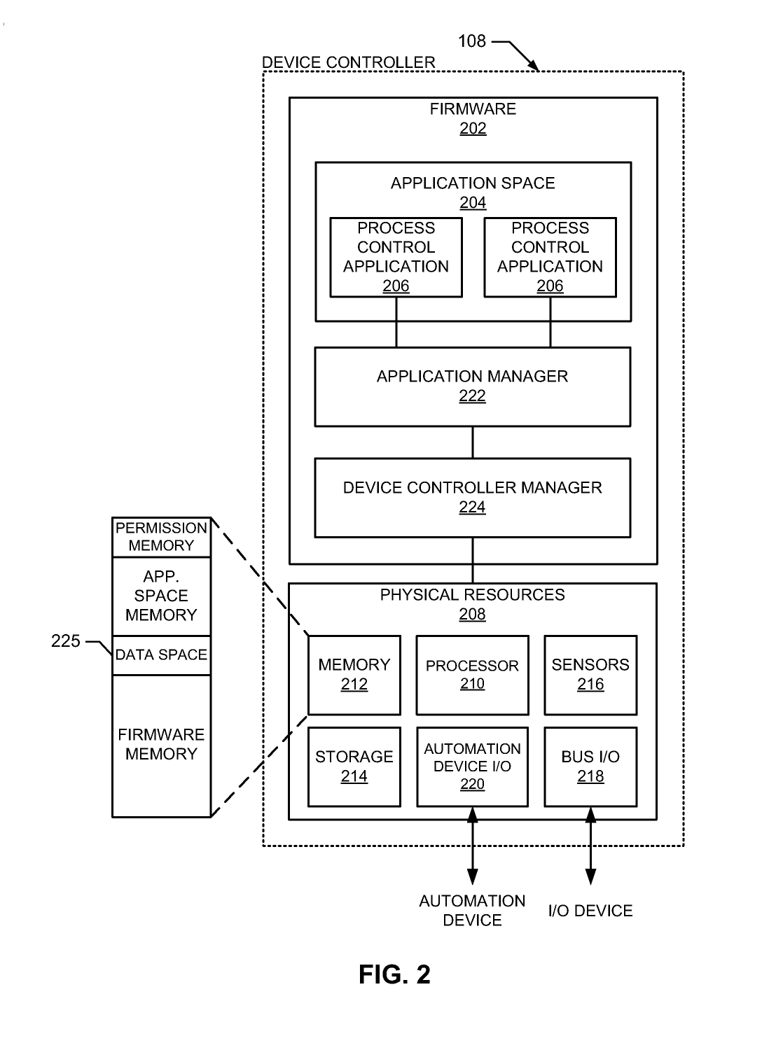

FIG. 2 illustrates an example implementation of the device controller 108 with firmware 202 that includes an example custom application space 204 to execute process control applications 206. In the illustrated example, device controller 108 includes the example firmware 202 and example physical resources 208. In the illustrated example, the physical resources 208 include an example processor 210, example memory 212, example non-volatile storage 214 (e.g., flash memory, hard disc, etc.), example sensors 216, an example bus I/O 218, and an example automation device I/O 220. The example firmware 202 includes the example application space 204, an example application manager 222, and an example device controller manager 224.

The example device controller manager 224 contains the functions to use the physical resources 208. For example, the device controller manager 224 can send and receive messages to the host 114 (FIG. 1) via the bus 102 (FIG. 1). In some examples, the device controller manager 224 may also contain functionality to manage the automation devices 104, 106 (FIG. 1). For example, the device controller manager 224 may read from sensors (e.g., pressure sensors, position sensors, etc.) of the automation devices 104, 106, calculate errors, and send control signals to the automation devices 104, 106 to maintain a desired set point. In the illustrated example, the device controller manager 224 also manages sharing of example processor 210 with the application manager 222 to allow both the device controller manager 224 to run process control functions and the application manager 222 to execute the process control applications 206.

In the example illustrated in FIG. 2, the application manager 222 manages the example process control applications 206 executing in the example application space 204. To isolate the application space 204 from the device controller manager 224, the example application manager 222 divides the example memory 212 and/or the example storage 214 between the application space 204 and the device controller manager 224. This isolation is maintained to prevent the process control applications 206 from accidentally or maliciously overwriting memory values used by the device controller manager 224. The example process control applications 206 are stored in the portion of the example memory 212 and/or the example storage 214 designated for the application space 204. Additionally, the example process control applications 206 may only read from and write to the portion of the example memory 212 and/or the example storage 214 designated for the application space 204. When a process control application 206 requests to write to the memory 212 and/or the storage 214, the example application manager 222 manages the request and writes to the designated portion of the example memory 212 and/or the example storage 214. When a process control application 206 requests to read from the memory 212 and/or the storage 214, the example application manager 222 manages the request and reads from the designated portion of the example memory 212 and/or the example storage 214.

In the illustrated example, the application manager 222 provides an application framework handler to moderate the access to the physical resources 208 of the device controller 108 by the process control applications 206. The process control applications 206 may be a compiled set of instructions or a script. When the process control application 206 is a compiled set of instructions, the application manager 222 provides the process control application 206 access to libraries of functions to access the physical resources 208 of the device controller 108. When the process control application 206 is a script, the application manager 222 interprets the script and provides access to the functions that access the physical resources 208 of the device controller 108. The example process control applications 206 makes a request (e.g., via a library call, via a hook, etc.) to the application manager 222 to access the physical resources 208 of the device controller 108.

In some examples, the application manager 222 and the device controller manager 224 define a data space 225 in the memory 212 and/or the storage 214. In such examples, the data space 225 is a space that the process control applications 206 and processes of the device controller manager 224 can read from and write to. In this manner, the example process control applications 206 are able to calculate process data that may be used by the processes of the device controller manager 224. For example, the process control application 206 may calculate a control value to be used to control a valve that is to be used by the device control manager 224. In some such examples, access to the data space 225 may be moderated by the application manager 222 through permission data. In some examples, to prevent read/write collision, access to the data space 225 is controlled by a semaphore. In some such examples, the semaphore prevents the process control application 206 from reading from the data space 225 while the device control manager 224 is writing to the data space 225, and/or prevents the device control manager 224 from reading from the data space 225 while the process control application 206 is writing to the data space 225.

The example application manager 222 grants or denies requests to access the physical resources 208 based on the permission data associated with the process control application 206 making the request. In the illustrated example, to prevent the process control application 206 from changing the permission data, the permission data is stored in a portion of the memory 212 and/or the storage 214 that is isolated from the application space 204. For example, if the process control application 206 is to send a message to the host 114, the application manager 222 checks the permission data associated with the process control application 206 to determine if the process control application 206 has permission to access the bus I/O 218. If the application manager 222 grants the request, the application manager 222 makes the corresponding function call with parameters (e.g., a message, values for a control signal, etc.) specified by the process control application 206. For example, if the process control application 206 does have permission to send a message to the host 114, the application manager 222 makes the appropriate function call. As another example, if the process control application 206 requests to read the value of a position sensor on a valve of the automation device 104, 106, the application manager 222 retrieves the value (e.g., request the firmware for the value) and passes the value to the process control application 206.

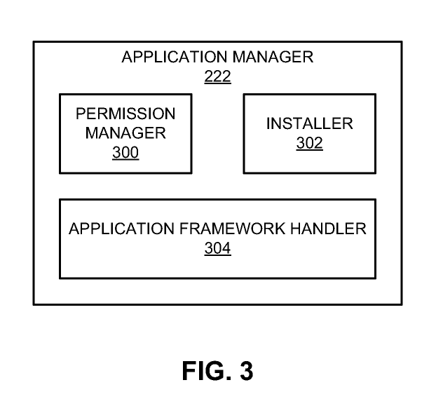

FIG. 3 illustrates an implementation of the example application manager 222 of FIG. 2 to manage process control applications 206 (FIG. 2) executing in the application space 204 (FIG. 2). The example application manager 222 includes an example permission manager 300, an example installer 302, and an example application framework handler 304. In the illustrated example, the permission manager 300 determines whether a process control application 206 executing in the application space 204 has permission to access particular physical resources 208 (FIG. 2) when the process control application 206 requests access (e.g., via a library function call, via a hook, etc.). To make the determination, the example permission manager 300 retrieves permission data from the memory 212 (FIG. 2) and/or storage 214 (FIG. 2).

When a process control application 206 requests access, the example permission manager 300 compares the requested access to the permission data. For example, if the process control application 206 makes a function call to send a control signal to an automation device 104, 106 via the automation device I/O 220 (FIG. 2), the permission manager 300 determines whether the associated permission data indicates that the process control application 206 can access the automation device I/O 220. If the permission data indicates the process control application 206 has permission to access the requested physical resource 208, the example permission manager 300 allows the corresponding function call to proceed.

In some examples, the permission manager 300 controls the frequency at which a process control application 206 may access particular physical resources 208. For example, the permission manager 300 may allow the process control application 206 to send a message to the host 114 (FIG. 1) only once every second to prevent the process control application 206 from accidently or maliciously performing a denial-of-service style attack against the system controller 110 (FIG. 1) and/or the host 114.

The example installer 302 manages the installation and uninstallation of the process control applications 206. The example installer 302 receives an example process control application 206 and the corresponding permission data from the host 114 via the bus I/O 218 (FIG. 2). The example installer 302 copies the process control application 206 to the portion of the memory 212 and/or the storage 214 provisioned for the application space 204. In some examples, the installer 302 copies the permission data to the portion of the memory 212 and/or the storage 214 provisioned for permission data. The example installer 302 then notifies the application framework handler 304 of the location of the beginning of the installed process control application 206 and notifies the permission manager 300 of the location of the permission data.

In the illustrated example of FIG. 3, the application framework handler 304 controls the execution of the installed process control applications 206. In some examples, the application framework handler 304 executes the installed process control applications 206 substantially continuously. Additionally or alternatively, in some examples, the application framework handler 304 executed the process control applications 206 a number of times in response to an event and/or trigger. For example, the application framework handler 304 may executed the process control applications 206 when a valve is closed or when a fault condition is detected. The application framework handler 304 schedules access to the processor (e.g., the processor 210 of FIG. 2) for the process control applications 206. In some examples, the application framework handler 304 interprets the process control application 206 (e.g., when the process control application 206 is a script). Additionally, the application framework handler 304 provides libraries and/or hooks that allow the process control application 206 to access the physical resources 208 of the device controller 108. For example, if the process control application 206 is to send a control signal to the automation device 104, 106, the process control application 206 includes a call to the automation device I/O function included in the application framework handler 304. The application framework handler 304, in conjunction with the permission manager 300, either allows the function call to proceed (e.g., the process control application 206 is associated with the corresponding permissions) or ignores the function call (e.g. the process control application 206 is not associated with the corresponding permissions). In such a manner, the application manger 222 moderates access to the physical resources 208.

While an example manner of implementing the example application manager 222 of FIG. 2 is illustrated in FIG. 3, one or more of the elements, processes and/or devices illustrated in FIG. 3 may be combined, divided, re-arranged, omitted, eliminated and/or implemented in any other way. Further, the example permission manager 300, the example installer 302, the example application framework handler 304 and/or, more generally, the example application manager 222 of FIG. 2 may be implemented by hardware, software, firmware and/or any combination of hardware, software and/or firmware. Thus, for example, any of the example permission manager 300, the example installer 302, the example application framework handler 304 and/or, more generally, the example application manager 222 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example permission manager 300, the example installer 302, and/or the example application framework handler 304 is/are hereby expressly defined to include a tangible computer readable storage device or storage disk such as a memory, a digital versatile disk (DVD), a compact disk (CD), a Blu-ray disk, etc. storing the software and/or firmware. Further still, the example application manager 222 of FIG. 2 may include one or more elements, processes and/or devices in addition to, or instead of, those illustrated in FIG. 3, and/or may include more than one of any or all of the illustrated elements, processes and devices.

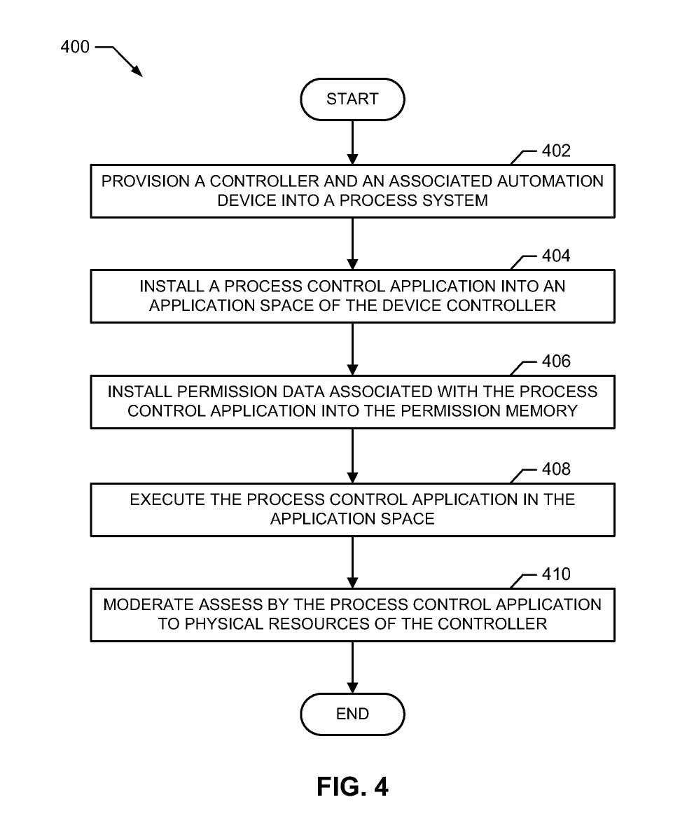

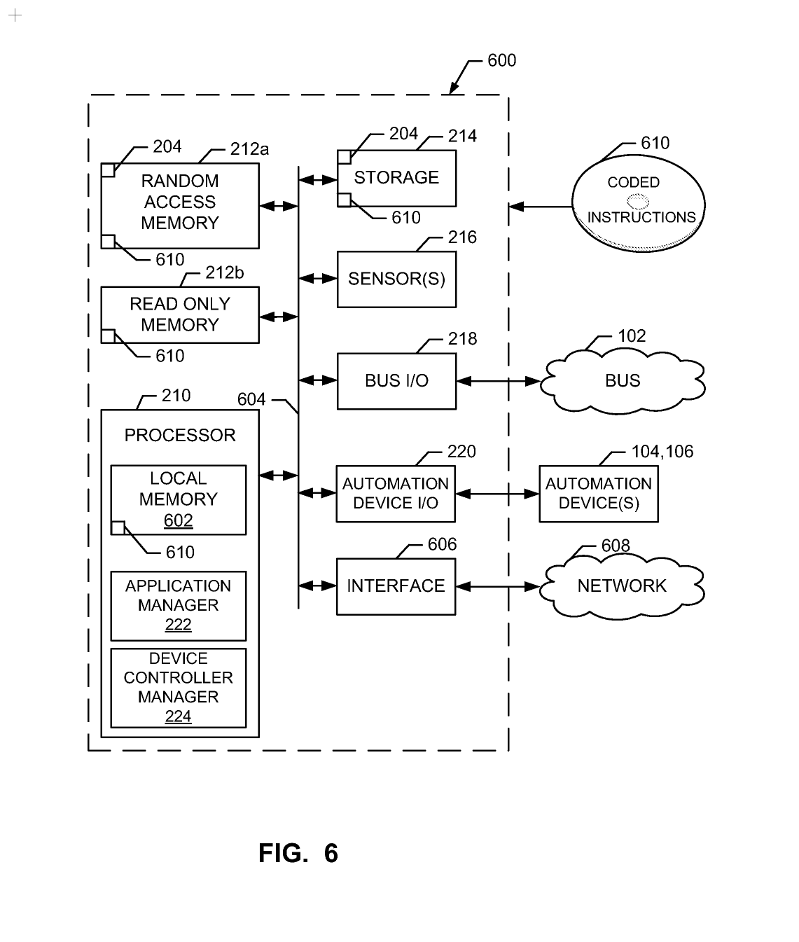

Flowcharts representative of example methods for implementing the example application manager 222 of FIGS. 2 and 3 is shown in FIGS. 4 and/or 5. In these example, the methods may be implemented using program(s) for execution by a processor such as the processor 210 shown in the example processor platform 600 discussed below in connection with FIG. 6. The programs may be embodied in software stored on a tangible computer readable storage medium such as a CD-ROM, a floppy disk, a hard drive, a digital versatile disk (DVD), a Blu-ray disk, or a memory associated with the processor 210, but the entire program and/or parts thereof could alternatively be executed by a device other than the processor 210 and/or embodied in firmware or dedicated hardware. Further, although the example program(s) is/are described with reference to the flowcharts illustrated in FIGS. 4 and/or 5, many other methods of implementing the example application manager 222 may alternatively be used. For example, the order of execution of the blocks may be changed, and/or some of the blocks described may be changed, eliminated, or combined.

As mentioned above, the example methods of FIGS. 4 and/or 5 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example methods of FIGS. 4 and/or 5 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

FIG. 4 is a flow diagram representative of an example method 400 that may be executed to implement the application manager 222 of FIGS. 2 and 3 to execute example process control applications 206 (FIG. 2) on the device controller 108 (FIGS. 1 and 2). The device controller manager 224 communicates with the system controller 110 (FIG. 1) and/or the host 114 (FIG. 1) to provision the device controller 108 in the process control system 100 (FIG. 1) (block 402). In some examples, to provision the device controller 108, the device controller manager 224 provides configuration information (e.g. device description files, device controller identifier, automation device identifier, general device information, range setup information, sensor/actuator parameters and/or tolerances, etc.) of the device controller 108 and/or the corresponding automation device 104, 106 (FIG. 1).

The application manager 222 installs the process control application(s) 206 received from the host 114 into the application space 204 of the device controller 108 (block 404). For example, the application manager 222 may place the process control application(s) 206 into a portion of the memory 212 and/or the storage 214 designated for the application space 204. The permission manager 300 installs permission data received from the host 114 associated with the process control application(s) 206 into a portion of the memory 212 and/or the storage 214 designated for permission data (e.g. permission memory) (block 406). The application manager 222 then manages the execution of the process control application(s) 206 (block 408). In some examples the application manager 222 interprets the process control application(s) 206.

The application manager 222 also moderates access by the process control application(s) 206 to the physical resources 208 of the device controller 108 (block 410). For example, if a process control application 206 requests access (e.g., via a library function call, via a script hook, etc.), the application manager 222 uses the permission data associated with the process control application 206 to determine whether the process control application 206 may access the particular physical resource 208. Additionally, to moderate access, the application manager 222 prevents the process control applications 206 from reading to or writing from the memory 212 and/or the storage 214 not defined for the application space 204.

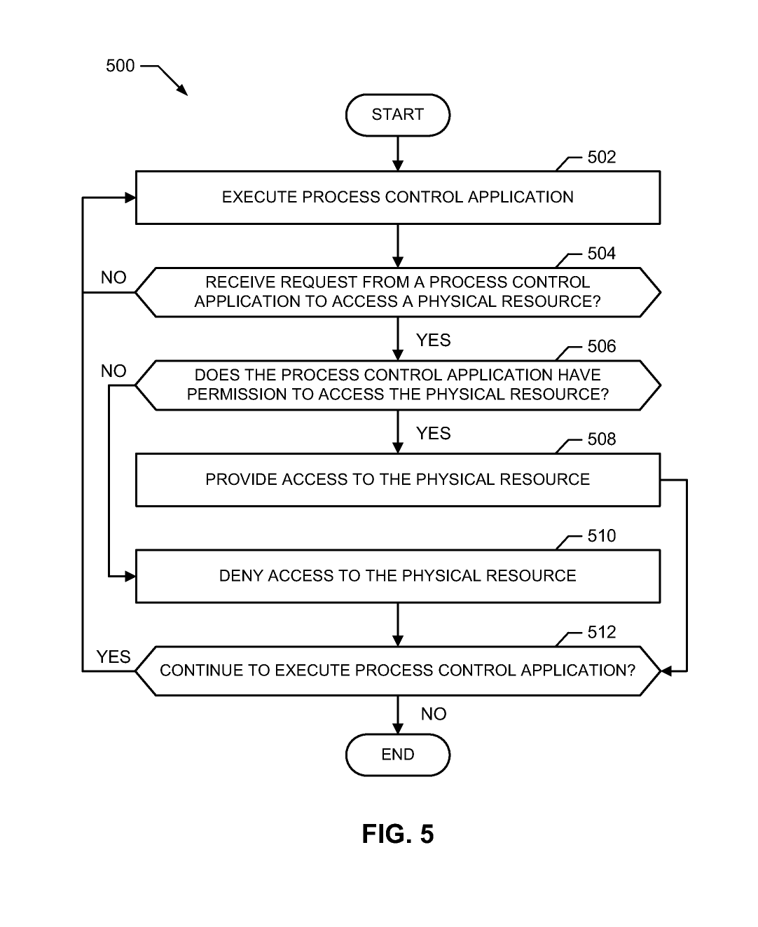

FIG. 5 is a flow diagram representative of an example method 500 that may be executed to implement the application manager 222 of FIGS. 2 and 3 to moderate access of an example process control application 206 (FIG. 2) to physical resources 208 (FIG. 2) of the device controller 108 (FIGS. 1 and 2). The application framework handler 304 (FIG. 3) manages the execution of the process control applications 206 (block 502). For example, the application framework handler 304 interprets the process control applications 206 and/or loads the starting location in the memory 212 (FIG. 2) into a program counter of the processor 210 (FIG. 2). The application framework handler 304 determines whether the process control application 206 requests access (e.g., via a library function call, via a script hook, etc.) to a physical resource 208 (block 504).

If the process control application 206 requests access to a physical resource 208, the permission manager 300 (FIG. 3) determines whether the process control application 206 has permission to access the particular physical resource 208 (block 506). To make the determination, the permission manager 300 checks the permission data associated with the particular process control application 206. If the process control application 206 does have permission to access the particular physical resource 208, the application framework handler 304 passes the request (e.g., via a library function, etc.) to the particular physical resource 208 (block 508). If the process control application 206 does not have permission to access the particular physical resource 208, the application framework handler 304 ignores the request (block 510). In some examples, the application framework handler 304 sets a flag and/or sends a message the host 114 to indicate that the process control application 206 attempted to access a physical resource 208 it did not have permission to access.

The application framework handler 304 determines whether to continue to execute the process control application 206 (block 512). If the application framework handler 304 is to continue to execute the process control application 206, the process 500 returns to block 502. Otherwise, the process 500 ends.

FIG. 6 is a block diagram of an example processor platform 600 structured to execute the methods of FIGS. 4 and 5 to implement the example device controller 108 of FIGS. 1 and 2, and/or the example application manager 222 of FIGS. 2 and 3. The processor platform 600 includes the physical resources 208 of FIG. 2 of the device controller 108.

The processor platform 600 of the illustrated example includes a processor 210. The processor 210 of the illustrated example is hardware. For example, the processor 210 can be implemented by one or more integrated circuits, logic circuits, microprocessors or controllers from any desired family or manufacturer.

The processor 210 of the illustrated example includes a local memory 602 (e.g., a cache). The processor 210 of the illustrated example is in communication with a main memory including a volatile memory 212a and a non-volatile memory 212b via a bus 604. The volatile memory 212a may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 212b may be implemented by flash memory and/or any other desired type of memory device. Access to the main memory 212a, 212b is controlled by a memory controller. The application space 204 may be defined for a section of the volatile memory 212a and/or the mass storage 214.

The processor platform 600 of the illustrated example also includes a bus I/O 218 and an automation device I/O 220. The bus I/O 218 and the automation device I/O 220 may be implemented by any type of interface standard, such as a Foundation Fieldbus, a Profibus, a Hart bus, an Ethernet interface, a universal serial bus (USB), and/or a PCI express interface.

In some examples, the processor platform 600 includes an interface circuit 606, which may include a communication device such as a transmitter, a receiver, a transceiver, a modem and/or network interface card to facilitate exchange of data with external machines (e.g., computing devices of any kind) via a network 608 (e.g., an Ethernet connection, a digital subscriber line (DSL), a telephone line, coaxial cable, a cellular telephone system, etc.).

The processor platform 600 of the illustrated example also includes one or more mass storage devices 214 for storing software and/or data. Examples of such mass storage devices 214 include floppy disk drives, hard drive disks, or any other suitable storage medium.

Coded instructions 610 to implement the methods of FIGS. 4 and 5 may be stored in the storage device 214, in the volatile memory 212a, in the non-volatile memory 212b, and/or on a removable tangible computer readable storage medium such as a CD or DVD.

In some examples, the processor platform 600 includes sensors 216 (e.g., temperature sensors, humidity sensors, accelerometers, etc.) that may be separate from the sensors of the automation device 104, 106. In some such examples, the sensors 216 may be used to monitor the conditions around the device controller 108 and/or detect anomalous behavior (e.g., fault detection, theft detection, etc.).

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method to manage comprising:
communicatively coupling a device controller to a host, the host to provision the device controller and an automation device within the process control system;
installing a process control application into an application space in firmware of the device controller, the process control application to be provided with permission data;
executing, via a processor, the process control application in the application space, the process control application to extend functionality of the device controller; and
moderating access by the process control application to physical resources of the device controller, the permission data to define which of the physical resources that the process control application has access.

2. A method as defined in claim 1, wherein moderating access by the process control application to the physical resources of the device controller includes maintaining an application memory space separate from a firmware memory space within the device controller, wherein the process control application has access to the application memory space, but not the firmware memory space.

3. A method as defined in claim 1, wherein moderating access by the process control application to the physical resources of the device controller includes providing the process control application access to network communication of the device controller, the permission data to specify a frequency at which the process control application is able to communicate with the host.

4. A method as defined in claim 1, wherein moderating access by the process control application to the physical resources of the device controller includes providing the process control application access to automation device communication to the device controller, the permission data to specify a frequency at which the process control application is able to communicate with the automation device.

5. A method as defined in claim 4, wherein the permission data specifies logic conditions that regulate when the process control application is able to communicate with the automation device.

6. A method as defined in claim 1, further including:
maintaining a data space, the process control application to write data to the data space to share with the firmware of the device controller; and
moderating access of the process control application to the data space based on the permission data.

7. A method as defined in claim 6, wherein the process control application is provided by at least one of the host when the process control application is installed or a manufacturer when the device controller is manufactured.

8. A device controller associated with an automation device to be installed in a process control system, the device controller comprising:
a device controller manager to communicatively couple the device controller to a host, the host to provision the device controller and the automation device within the process control system;
an installer to install a process control application into an application space in firmware of the device controller, the process control application to be provided by the host with permission data;
an application framework handler to:
execute the process control application in the application space, the process control application to extend functionality of the device controller; and
moderate access by the process control application to physical resources of the device controller, the permission data to define rules to moderate the access by the process control application to the physical resources of the device controller.

9. A device controller as defined in claim 8, wherein to moderate access by the process control application to the physical resources of the device controller, the application framework handler is to maintain an application memory space separate from a firmware memory space within the device controller, wherein the process control application has access to the application memory space, but not the firmware memory space.

10. A device controller as defined in claim 8, wherein to moderate access by the process control application to the physical resources of the device controller, the application framework handler is to provide the process control application access to network communication of the device controller, the permission data to specify a frequency at which the process control application is able to communicate with the host.

11. A device controller as defined in claim 8, wherein to moderate access by the process control application to the physical resources of the device controller, the application framework handler is to provide the process control application access to automation device communication to the device controller, the permission data to specify a frequency at which the process control application is able to communicate with the automation device.

12. A method as defined in claim 11, wherein the permission data specifies logic conditions that regulate when the process control application is able to communicate with the automation device.

13. A device controller as defined in claim 8, wherein to moderate access by the process control application to the physical resources of the device controller, the application framework handler is to maintain a data space, the process control application to write data to the data space to share with the firmware of the device controller.

14. A device controller as defined in claim 13, wherein to moderate access by the process control application to the physical resources of the device controller, the application framework handler is to moderate access of the process control application to the data space based on the permission data.

15. An article of manufacture comprising instructions which, when executed, cause a device controller to at least:
communicatively couple the device controller to a host, the host to provision the device controller and the automation device within the process control system;
install a process control application into an application space in firmware of the device controller, the process control application to be provided by the host with permission data;
execute the process control application in the application space, the process control application to extend functionality of the device controller; and
moderate access by the process control application to physical resources of the device controller, the permission data to define rules to moderate the access by the process control application to the physical resources of the device controller.

16. An article of manufacture as defined in claim 15, wherein to moderate access by the process control application to the physical resources of the device controller, the instructions cause the device controller to maintain an application memory space separate from a firmware memory space within the device controller, wherein the process control application has access to the application memory space, but not the firmware memory space.

17. An article of manufacture as defined in claim 15, wherein to moderate access by the process control application to the physical resources of the device controller, the instructions cause the device controller to provide the process control application access to network communication of the device controller, the permission data to specify a frequency at which the process control application is able to communicate with the host.

18. An article of manufacture as defined in claim 15, wherein to moderate access by the process control application to the physical resources of the device controller, the instructions cause the device controller to provide the process control application access to automation device communication to the device controller, the permission data to specify a frequency at which the process control application is able to communicate with the automation device.

19. An article of manufacture as defined in claim 18, wherein the permission data specifies logic conditions that regulate when the process control application is able to communicate with the automation device

20. An article of manufacture as defined in claim 15, the instructions cause the device controller to maintain a data space, the process control application to write data to the data space to share with the firmware of the device controller.
